(19) United States
(12) Patent Application Publication
(10) Pub. No.: US 2009/0235280 A1
(43) Pub. Date: Sep. 17, 2009

(54) EVENT EXTRACTION SYSTEM FOR ELECTRONIC MESSAGES

(75) Inventors: Xavier Tannier, Paris (FR); Claude Roux, Grenoble (FR)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: Xerox Corporation, Norwalk, CT (US)

(21) Appl. No.: 12/046,743

(22) Filed: Mar. 12, 2008

(51) Int. Cl. G06F 3/00

(52) U.S. Cl. 719/318

(57) ABSTRACT

An event extraction system includes a temporal module which extracts temporal expressions in text content of an electronic mail message. A calendar entry generation module generates a candidate calendar entry based on an extracted temporal expression and presents it to a user for consideration as a calendar entry. The candidate calendar entry can be displayed in a transient pop up window, allowing a user to ignore the candidate entry or to accept it.

### BACKGROUND

The exemplary embodiment relates to information extraction and in particular to a system and method for identifying information in a message relating to an event and for presenting the information to a user as a candidate calendar entry.

E-mail is now a widely accepted method for requesting meetings and sending reminders about upcoming activities. Keeping track of all the events described in such e-mail communications can be difficult because the relevant information may be dispersed in the text. Electronic calendars are increasingly used to organize and schedule events, such as activities, reminders, appointments, meetings, and the like. Such calendars are generally stored in memory and accessed from a computing device, such as a desktop computer or portable computing device, e.g., a laptop computer, personal digital assistant (PDA), mobile phones, or wearable computer.

Calendar entries are individually created, typically one for each event. A user interfaces with the calendar via a graphical user interface which displays a blank event form with appropriate fields (such as entry boxes) for adding information, such as the name of the event, its location, date, and start and end times. The process of filling out electronic calendar entries can be time consuming. Rather than typing the information in the fields, a user may cut and paste information from an e-mail message or accompanying attachment. Even this can be time consuming because of the number of different fields.

Systems have been developed for identifying information in e-mails. However, these generally rely on the identification of one of a limited set of regular expressions.

There remains a need for a system and method for automatically generating calendar entries based on e-mail content.

### INCORPORATION BY REFERENCE

The following references, the disclosures of which are incorporated herein in their entireties by reference, are mentioned:

U.S. Pub. No. 20030177190, entitled METHOD AND APPARATUS FOR INTERACTION WITH ELECTRONIC MAIL FROM MULTIPLE SOURCES, by Paul B. Moody, et al., discloses an electronic mail inbox which uses a mail agent to categorize incoming electronic mail to facilitate more flexible and rapid viewing and possible response thereto.

U.S. Pub. No. 20070130194, entitled PROVIDING NATURAL-LANGUAGE INTERFACE TO REPOSITORY, by Matthias Kaiser, discloses a natural-language interface. Information from a repository is used to generate a computer-readable ontology. The computer-readable ontology is configured for use in interpreting user-entered natural-language statements regarding the repository.

U.S. Pub. No. 20070179776, entitled LINGUISTIC USER INTERFACE, by Frederique Segond, et al., discloses a system for retrieval of text which includes a processor which identifies grammar rules associated with text elements of a text string that is retrieved from an associated storage medium, and retrieves text strings from the storage medium which satisfy the grammar rules.

U.S. Pat. No. 7,058,567, entitled NATURAL LANGUAGE PARSER, by Salah Aït-Mokhtar, et al. discloses a finite state parser which may be utilized in natural language processing.

### BRIEF DESCRIPTION

In accordance with one aspect of the exemplary embodiment, an event extraction system includes a temporal module that includes instructions stored in memory for extracting temporal expressions in syntactically parsed text content of an electronic mail message. A calendar entry generation module includes instructions stored in memory for generating a candidate calendar entry based on an extracted temporal expression and for presenting it to a user for consideration as a calendar entry. A processor associated with the temporal module and calendar entry generation module executes the instructions.

In accordance with another aspect of the exemplary embodiment, a computer implemented method for extracting events from an electronic message includes extracting temporal expressions in text content of an electronic mail message, generating a candidate calendar entry based on an extracted temporal expression, and presenting the candidate calendar entry to a user for consideration as a calendar entry.

In accordance with another aspect of the exemplary embodiment, an automated event extraction system includes memory which stores instructions and a processor which executes the instructions for extracting temporal expressions in text content of an electronic mail message, identifying events associated with the extracted temporal expressions, computing temporal information from the temporal expressions, generates a candidate calendar entry based on the computed temporal information, and displaying the candidate calendar entry transiently on a screen.

### BRIEF DESCRIPTION OF THE DRAWINGS

FIG. 1 is a functional block diagram of an environment in which an event extraction system operates in accordance with one aspect of the exemplary embodiment;

FIG. 2 illustrates a method for extraction of events in accordance with another aspect of the exemplary embodiment;

FIG. 3 is a functional block diagram of an embodiment of the event extraction system of FIG. 1;

FIG. 4 graphically illustrates the processing of an exemplary e-mail message for forming a candidate calendar entry;

FIG. 5 illustrates two candidate calendar entries generated from another email message;

FIG. 6 illustrates another candidate calendar entry generated from another email message; and

FIG. 7 illustrates three candidate calendar entries generated from another email message.

### DETAILED DESCRIPTION

A method and a system are disclosed which address the problem of keeping track of upcoming events through careful analysis of a user's e-mails and an automatic suggestion of events (e.g., meetings, appointments, etc.) to be added to a calendar, according to the content of the message. The suggestions are discreet enough, such that the user may ignore them.

In one aspect of the exemplary embodiment, an event extraction system processes incoming electronic mail messages for a user, such as e-mails or SMS messages (text messages), to identify references to a future event. Where such references are detected, the system generates a candidate calendar entry in a suitable format for presenting to the user, which may be used to update an electronically stored calendar for the user.

Briefly, when a new e-mail arrives in the user's inbox, it is immediately analyzed by the event extraction system. The system extracts every future date and named entity which could be a candidate participant or location from the message. An event is created for each identified date. Participant and location names, as well as pre-defined keywords (for the event's topic), are added to the event information if they appear close to the date. The list of events in the form of candidate calendar entries is then suggested to the user. In one embodiment, the candidate calendar entry may be presented via a transient pop-up window on the user's computing device which provides the user to the opportunity to accept the candidate calendar entry, modify it, delete it, or simply ignore it. In another embodiment, the candidate calendar entry may be displayed when the user reads the corresponding message. If one event is considered as relevant (or partly relevant), the corresponding information can be edited (if for instance, the user decides to enrich the information) and the event is then added into the user's calendar in one click.

An advantage of such a system is that a user can review the candidate calendar entry before it is added to the calendar.

The exemplary event extraction system includes a natural language processor, such as a syntactic parser with a regular natural language grammar. The natural language grammar is enhanced with a temporal module for extracting temporal expressions. Once identified, these temporal expressions can be further processed to extract the temporal information they contain (such as inferring that “tomorrow” refers to the next date on the calendar after the e-mail's sent date).

A temporal expression, as used herein, can be any piece of information that describes a time or a date, generally in the future, such as “today,” “tomorrow,” “on Friday,” “next Thursday,” “in two hours”, “in ten days time” as well as specific references to dates and times. Exemplary temporal expressions which may be found in a document are underlined in the sentences below:

a) I suggest a meeting on Monday

b) The meeting will be today at 4.30 PM

c) The conference will be held in Paris, on the 20^{th} of January, starting at 9.00 AM

d) Let's talk about it in thirty minutes.

The temporal module automatically detects these expressions within the different sentences in the text content of the e-mail message, which are then passed to another module, which is referred to herein as a temporal reference computation module. This module computes the actual date corresponding to these expressions. The exemplary event extraction system always takes as an assumption that the date in the text content is in the future relative to the sent date of the message.

Event topics are also identified, such as those shown in italic in the exemplary sentences above. Event topics, as used herein, can be text elements referring to meetings, appointments, etc. The definition of what is considered to be an event topic may depend on the application.

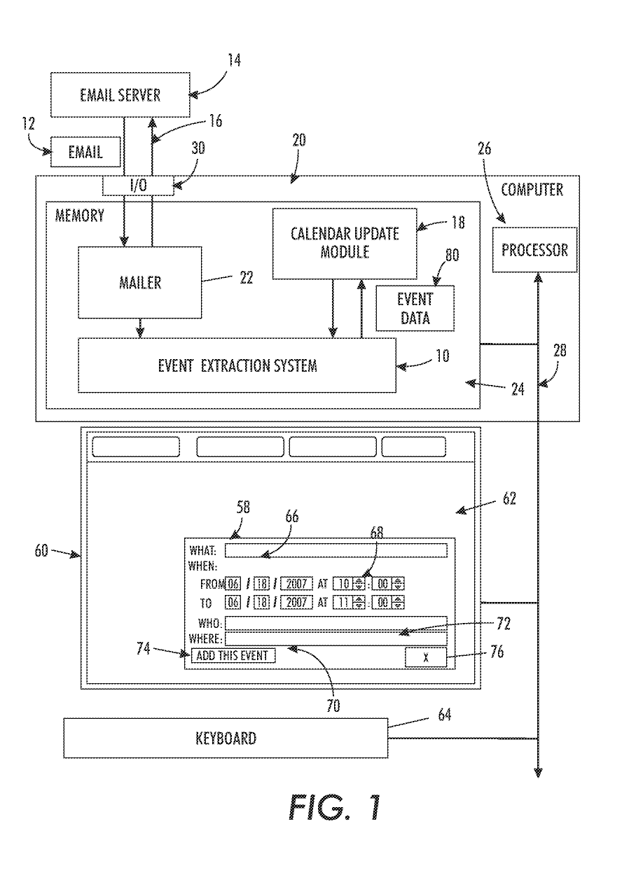

With reference to FIG. 1 an exemplary event extraction system 10 of the type described above is illustrated in an operating environment. The event extraction system 10 receives incoming e-mails 12 from an external source, such as an e-mail server 14. A network 16, such as an internet connection, a local area network, a corporate data network, telephone line, or other wired or wireless link, serves as an electronic conduit for the e-mails 12. The system 10 communicates with a calendar update module 18 configured for updating an electronic calendar based on the information provided to it.

The event extraction system 10 may be hosted by a computing device 20, such as one or more general purpose computing devices or dedicated computing device(s), such as a desktop computer, laptop computer, personal digital assistant, cell phone or other device with e-mail receiving capability. In other embodiments, the system 10 may be at least partly resident on a server in communication with a user's computing device. The computer 20 hosts an e-mail program or mailer 22, stored in memory 24, which contains computer program instructions for implementing an electronic mail application for creating and sending e-mail messages and attachments. Electronic mail applications are well known, such as Microsoft Outlook™ and Netscape Messenger™ systems.

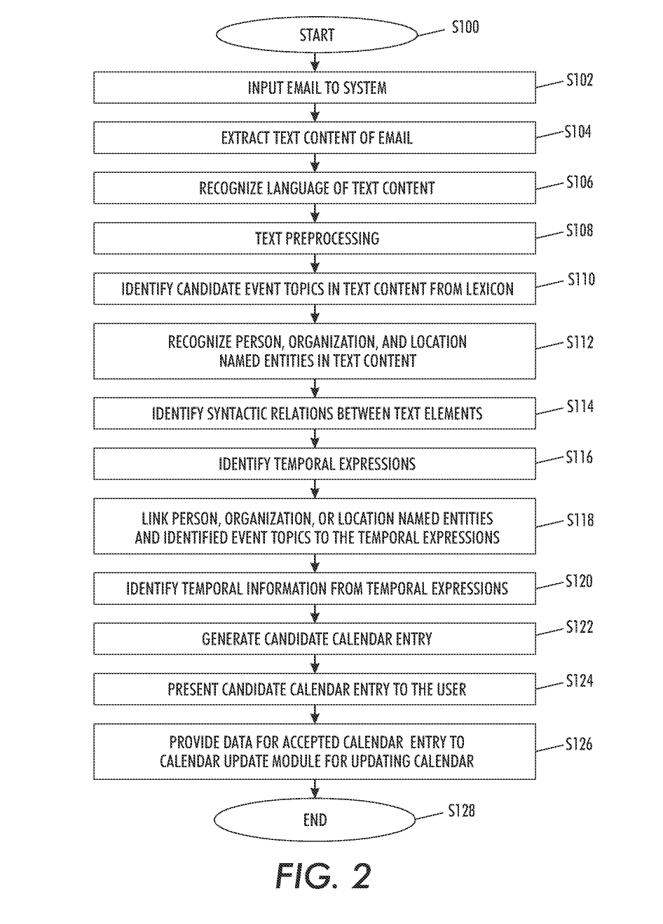

The event extraction system 10 may be embodied in hardware, software, or a combination thereof. In one embodiment, the event extraction system 10 serves as a plug-in component to the mailer 22 or calendar update module 18. In the illustrated embodiment, the system 10 comprises processing instructions, stored in memory 24, which are executed by an associated processor 26. In particular, the processor 26 executes computer program instructions stored in memory 24 for implementing the exemplary extraction method described below with reference to FIG. 2. The components of the computing device 20 may communicate via a data/control bus 28. A network interface 30 allows the computer 20 to communicate with other devices via the computer network 16, and may comprise a modulator/demodulator (MODEM).

The processor 26 may comprise one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, or PAL, or the like. In general, any device, capable of implementing a finite state machine that is in turn capable of implementing the flowchart shown in FIG. 2, can be used as the processor.

The calendar update module 18 may be hosted by computer 20 or may be remote therefrom and connected to the computer via the network 16, and may also be embodied in hardware and/or software. The calendar update module 18 contains computer program instructions for updating an electronic calendar in accordance with the user accepted calendar entry.

The memory or memories 24 may represent any type of computer readable medium such as random access memory (RAM), read only memory (ROM), magnetic disk or tape, optical disk, flash memory, or holographic memory. In one embodiment, the memory 24 comprises a combination of random access memory and read only memory. Memory 24 stores instructions for performing the exemplary method as well as the processed e-mails 12 and references to candidate events extracted therefrom.

As will be appreciated, FIG. 1 is a high level functional block diagram of only a portion of the components which are incorporated into the computer 20. Since the configuration and operation of programmable computers are well known, they will not be described further.

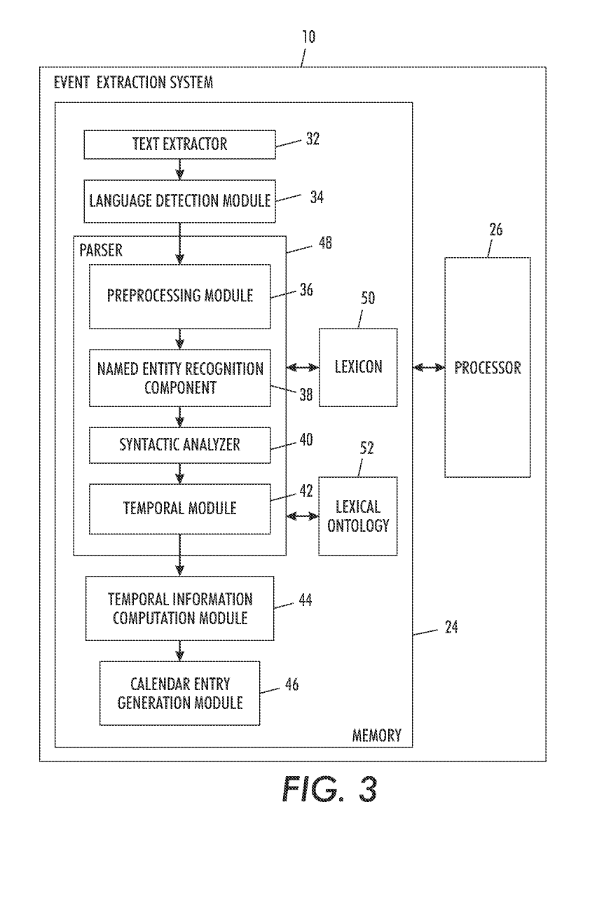

The event extraction system 10 performs natural language processing (NLP) on the textual content of the e-mail 12 to identify references to an event. As illustrated in FIG. 3, the event extraction system 10 includes various processing components 32, 34, 36, 38, 40, 42, 44, 46, which are described, for ease of discussion, as separate modules, although it is to be appreciated that one or more of these may be combined. The processing components may work on the input of a prior module. In some cases, text may be returned to a prior module for further processing.

The exemplary processing components include a text extractor 32, which extracts text content to be processed; an optional language detection module 34, which detects the language used; a preprocessing module 36, which performs standard linguistic preprocessing; a named entity recognition component 38, which identifies named entities, particular those of type PERSON, ORGANIZATION, or LOCATION; a syntactic analyzer 40, which identifies relationships between text elements; a temporal module 42, which identifies temporal expressions and links between them and candidate event topics, participants, and locations; a temporal information computation module 44, which computes temporal information from the identified temporal expressions; and a candidate calendar entry generation module 46; which supplies data from an accepted calendar entry to the calendar update module 18. Some of these modules may be incorporated into a natural language processor, here illustrated as a syntactic parser 48. The temporal module 42, for example, may be incorporated as additional processing rules on top of the core grammar.

The exemplary parser 48 has access to a lexicon 50 and a lexical ontology module 52. Lexicon 50 indexes words according to their parts of speech. As part of lexicon 50, or a separate lexicon, indexes words which are classed as event topic words. In particular, lexicon 50, which may be in the form of finite state transducers, indexes a set of words which are classed as representing event topics (meeting, appointment, etc.) allowing these to be tagged accordingly. Lexical ontology 52 indexes named entities according to their type, in particular PERSON, ORGANIZATION, and LOCATION named entities. Lexicon 50 and lexical ontology 52 may be stored in memory 24 or elsewhere, such as at a remote location which is accessed via the Internet.

While the exemplary system 10 is illustrated as being physically located on a single computing device 20, it is to be appreciated that one or more components 32, 34, 36, 38, 40, 42, 44, 46, 48, 50, and 52 or subcomponents of the system 10 may be remote from one another, e.g., on a client and server.

With reference once more to FIG. 2, a flowchart illustrating an exemplary event extraction method is shown, which may be performed with the event extraction system shown in FIGS. 1 and 2. As will be appreciated, the method may include fewer, more, or different steps and that the steps need not all proceed in the order illustrated. The method begins at S100.

At S102, an e-mail 12 is input to the system 10.

At S104, text content is extracted from the e-mail.

At S106, the text content may be processed to determine whether it includes text recognized as being in the language (or one of the languages) accepted by the event extraction system 10.

At S108, preprocessing of the e-mail text is performed. The processing may be performed on the body of the e-mail, the e-mail header, any attachments, or a combination thereof.

At S110, which may be a part of S108, candidate event topics are tagged.

At S112, which may be performed at an earlier or later stage, text elements corresponding to named entities may be identified by the named entity recognition (NER) component 54, and labeled as such, in particular, those named entities recognized as PERSON, ORGANIZATION, or LOCATION.

At S114, the text elements of a text string, such as a sentence, in the input text are processed by the parser to identify syntactic relations between text elements, such as between words or groups of words.

At S116, temporal expressions are extracted.

At S118, identified named entities of the PERSON, ORGANIZATION, or LOCATION type and identified event topics are linked to the temporal expressions.

At S120, the temporal expressions are processed to identify temporal information (dates and times) from these expressions.

At S122, a candidate calendar entry is generated using the identified temporal information as well as any linked person, location, and event topic information extracted from the text content. A single e-mail 12 may give rise to multiple candidate calendar entries, for example, where there is more than one possible date and/or time identified in the temporal information.

At S124, the candidate calendar entry is presented to the user, with an opportunity to make modifications.

At S126, if the user accepts the candidate calendar entry, information from the calendar entry and any user input modifications is forwarded to the calendar update module 18 for updating the user's calendar. The events are then stored within the current user's calendar system.

The method ends at S128, and can be repeated with each new e-mail 12 that is input. Further details of the exemplary system 10 and method now follow.

### E-mail Input (S102)

In one embodiment all received e-mails 12 are automatically input to the system 10. In other embodiment, a selected class or classes of e-mails, such as only those e-mails not filtered out as being spam or e-mails only from trusted senders, is input. When a new e-mail is received, it is promptly analyzed by the event extraction system 10.

### Text Extraction (S104)

The text extractor 32 extracts text from the content of the e-mail 12. If the content of interest is purely text, then the text extractor 32 is optionally omitted. However, in embodiments in which the content may include attachments such as word processing documents, presentation files, portable document format (pdf) files, or the like, or where the content is in a marked-up or otherwise annotated format such as HTML, the text extractor 32 extracts content text from the attachments or annotated content using algorithms suitable for the particular format of the attachment or annotation scheme.

### Language Recognition (S106)

The optional language detection module 34 includes instructions for detecting the language used in an e-mail 12. The event extraction system 10 may be configured for a particular natural language, such as English. Optionally, the text extractor 32 includes different modules appropriate to different languages. Text which is not in one of the recognized languages may be ignored, flagged as not being processable, or translated prior to further processing.

### Syntactic Parser

The event extraction system 10 relies on natural language processing (NLP) techniques to identify linguistic elements in a text string in a natural language, such as English. This function may be performed by a linguistic parser. The parser takes a text document as input and breaks each sentence into a sequence of tokens (linguistic elements) of the type described above. The parser provides this functionality by applying a set of rules, called a grammar, dedicated to a particular natural language such as French, English, or Japanese. The grammar is written in the formal rule language, and describes the word or phrase configurations that the parser tries to recognize. The basic rule set used to parse basic documents in French, English, or Japanese is called the “core grammar.” Through use of a graphical user interface, a grammarian can create new rules to add to such a core grammar. In some embodiments, the syntactic parser employs a variety of parsing techniques known as robust parsing, as disclosed for example in Salah Aït-Mokhtar, Jean-Pierre Chanod, and Claude Roux, “Robustness beyond shallowness: incremental dependency parsing,” in special issue of the NLE Journal (2002); above-mentioned U.S. Pat. No. 7,058,567; and Caroline Brun and Caroline Hagège, “Normalization and paraphrasing using symbolic methods” ACL: Second International workshop on Paraphrasing, Paraphrase Acquisition and Applications, Sapporo, Japan, Jul. 7-12, 2003 (hereinafter Brun and Hagège). These example natural language processing techniques are well suited for analysis of e-mail content which can sometimes be grammatically informal or can use a telegraphic style that does not employ grammatically complete sentences and paragraphs. Other natural language processing or parsing algorithms can be used. In one embodiment the syntactic parser may be based on the Xerox Incremental Parser (XIP), which has been enriched with additional processing rules to facilitate the extraction of references to events.

The incremental parser incorporates a pre-processing stage which handles tokenization, morphological analysis and POS tagging (S108). Specifically, the preprocessing module breaks the input text into a sequence of tokens, each generally corresponding to a text element, such as a word, or punctuation. Parts of speech are identified for the text elements, such as noun, verb, etc. Some tokens may be assigned more than one part of speech. The tokens are tagged with the identified parts of speech.

A surface syntactic analysis stage consists of chunking the input to identify groups of words, such as noun phrases. This stage may also include a Named Entity Recognition (NER) process (S112), as described below. A deeper syntactic analysis performs first a simple syntactic dependency analysis and then a deep analysis.

The exemplary parser 48 performs robust and deep syntactic analysis. “Robust” means here that any kind of text can be processed by the parser (including output of an OCR system or ill-formed input). “Deep” means that linguistic information extracted by the parser can be of a subtle nature and not necessarily straightforward. XIP extracts not only superficial grammatical relations in the form of dependency links, but also basic thematic roles between a predicate (verbal or nominal) and its arguments. For syntactic relations, long distance dependencies are computed and arguments of infinitive verbs are handled. See (Brun and Hagège) for details on deep linguistic processing using XIP. The deeper syntactic analysis performs first a simple syntactic dependency analysis and then a deep analysis. The syntactic analysis part of the text parsing (S114) is used to identify events in which the recipient is the agent who is to participate.

Deep syntactic analysis processing of sentences is suitably used to identify action verbs indicative of participation, and to identify content setting forth events in which the e-mail message recipient is the designated agent for participating in the event. More generally, deep syntactical analysis enables processing of various complex linguistic forms to identify the agent. Deep syntactic analysis enables determination of action items in which the recipient e-mail user is expected to do something. For example, deep syntactic analysis may employ lexical semantics associated to predicates that appear in text and linguistic links between those predicates and linguistic objects that denote the user.

Further extensions to the core grammar tool, dealing for example with pronominal co-reference or metonymy of named entities, can be plugged in.

### Event Topic Identification (S110)

The event extraction system 10 looks for a specific set of words which are indexed as being event topics, such as meeting, appointment, lunch, dinner, travel, etc. This set of event topic words may be stored in the lexicon 50, or a separate lexicon that is suitable for the natural language in which the e-mail message content 12 is written. These words may be stored in an ontology by providing synonyms for some words. Thus, for example, the event topic lunch may be considered as a meeting, allowing retrieval of related events with a search engine. The ontology may be specific to the application. For example, it may be enriched with specific event topics commonly used in the user's or company's calendars. The event extraction system 10 may also identify other linguistic elements which refer to an event and which can be used to generate an event topic. In the exemplary embodiment, candidate event topics (that can be temporally marked) may include those having the one or more of the following linguistic elements:

Any verb expressing either an action or a state

Any deverbal noun, when there is a clear morphological link between this noun and a verb (e.g. “interaction” is a derivation of the verb “interact”)

Any noun which is not a deverbal noun and that can be any of:
An argument of the preposition “during”
A subject of the verb “to last”
A subject of the verb “to happen” or “to occur”, when these verbs are modified by an explicit temporal expression.

These nouns are referred to as time span nouns. Examples of such nouns are words such as “sunrise” and “football game” that intuitively correspond to nouns denoting an event of certain duration.

A list of such nouns and verbs can be obtained by applying the above-mentioned heuristics to a corpus of text strings, such as the Reuters corpora at NIST and/or a more application specific set of text strings, such as company e-mails, company literature with employee and location information, and the like. The list can be stored in memory 24.

### Named Entity Recognition (S112)

Named entities are proper nouns which are recognized as being in a particular class from a set of classes, such as PERSON, LOCATION, ORGANIZATION, etc. Methods for named entity extraction may be performed in a variety of ways, such as through accessing an on-line or off-line resource, such as WordNet® or other lexical ontology 52. In particular, through access to one or more lexical ontologies 52, the NER component identifies named entities corresponding to person, organization, and location names. The organization and person names identified are tagged as candidate participants in an event. The identified location names as tagged as candidate locations for the event. Moreover, add-ons to the lexicon optionally include organization-specific entries, such as the names of specific corporate projects or committees, and the like, that may be expected to be used in connection with event items (e.g., as participants or locations).

Where the text content identifies only a portion of the named entity, the supplemented lexicon 50 may be used supplement this information.

Further details on the process of named entity recognition are to be found in application Ser. No. 11/846,740, filed Aug. 29, 2007 (Atty. Docket No. 20070362-US-NP), entitled A HYBRID SYSTEM FOR NAMED ENTITY RESOLUTION, by Caroline Brun, et al.; application Ser. No. 12/028,126, filed Feb. 8, 2008 (Atty. Docket No. 20071270-US-NP), entitled SEMANTIC COMPATIBILITY CHECKING FOR AUTOMATIC CORRECTION AND DISCOVERY OF NAMED ENTITIES, by Caroline Brun, et al.; and U.S. Pub. No. 20060136196, entitled BI-DIMENSIONAL REWRITING RULES FOR NATURAL LANGUAGE PROCESSING, by Caroline Brun, et al., the disclosures of which are incorporated herein in their entireties by reference.

### Temporal Expression Extraction (S116)

The temporal module 42 serves to extract temporal expressions from the e-mail text content, and may be incorporated into the syntactic parser 48, as noted above. In performing the identification of temporal expressions, the temporal module 42 may access the lexicon 50. The lexicon may be enriched with a set of standard temporal expression terms, such as “tomorrow”, “by the end of the month”, “end-of-quarter”, “end of fiscal year”, and the like, along with information as to how the corresponding dates are calculated.

Many temporal expressions, however, do not follow standardized formats of the type which can be stored in a lexicon. For such expressions, the temporal module identifies an anchor word which relates to time, such as minute(s), hour(s), day(s), week(s), month(s), today, tomorrow, Monday, o'clock, quarter, year, and the like. A temporal expression is then built from the anchor word and optionally other words associated with the anchor word.

Temporal relations are then identified in which the temporal expression forms a dependency or is otherwise linked with references to an event. The set of temporal relations can include some or all of the following: AFTER, BEFORE, DURING, INCLUDES, OVERLAPS, IS_OVERLAPPED and EQUALS. They are defined as equivalent or disjunctions of Allen's 13 relations (James Allen, Towards a general theory of action and time. Artificial Intelligence, 23:123-154 (1984)). Allen's temporal relations, although similar, are not amenable to most fuzzy natural language situations. The exemplary temporal relations are simpler than those employed by Allen but keep basic properties of Allen algebra, such as mutual exclusivity, exhaustivity, inverse relations and the possibility to compose relations. Further details of these temporal relations are to be found in Philippe Muller and Xavier Tannier. Annotating and measuring temporal relations in texts. In Proceedings of the 20^{th} International Conference on Computational Linguistics (COLING'04), Geneva, Switzerland, pages 50-56 (2004).

In general, references to past events are of less relevance. Thus, for example, the sentence “the meeting lasted for 20 minutes” is of less interest to the system 10 than “the meeting will last for 20 minutes.”

The temporal processing has the following purposes: recognizing and interpreting temporal expressions, attaching these expressions to the corresponding events they modify, and ordering these events using a set of temporal expressions of the type shown above. The processing of temporal expressions may include three main levels. At the first level (local level), the main task is the recognition of temporal expressions.

The next level (sentence level) establishes links between temporal expressions and the events they modify as well as temporal relations between events in the same sentence. For example, a specific relation TEMP links the temporal expression and the predicate it is attached to. Thus for example, in sentence “The meeting will be today at 4.30 PM until 5.30 PM”, the following dependencies are extracted:

TEMP (meeting, today)

TEMP (meeting, at 4.30 PM)

TEMP (meeting, until 5.30 PM)

The third level (document level) looks to surrounding sentences for missing information which has not been found in the sentence in which a temporal expression has been found, such as the location of the event and the participant, which may be a person or group of people which are participating/hosting, organizing, or otherwise involved in the event. Further details on the extraction of temporal relations between temporal expressions and the events which they relate to are to be found in Caroline Hagège and Xavier Tannier, XRCE-T: XIP temporal module for TempEval campaign, Proc. 4^{th} Intl. Workshop on Semantic Evaluations (SEmEval-2007), pp. 492-495, Prague, June 2007.

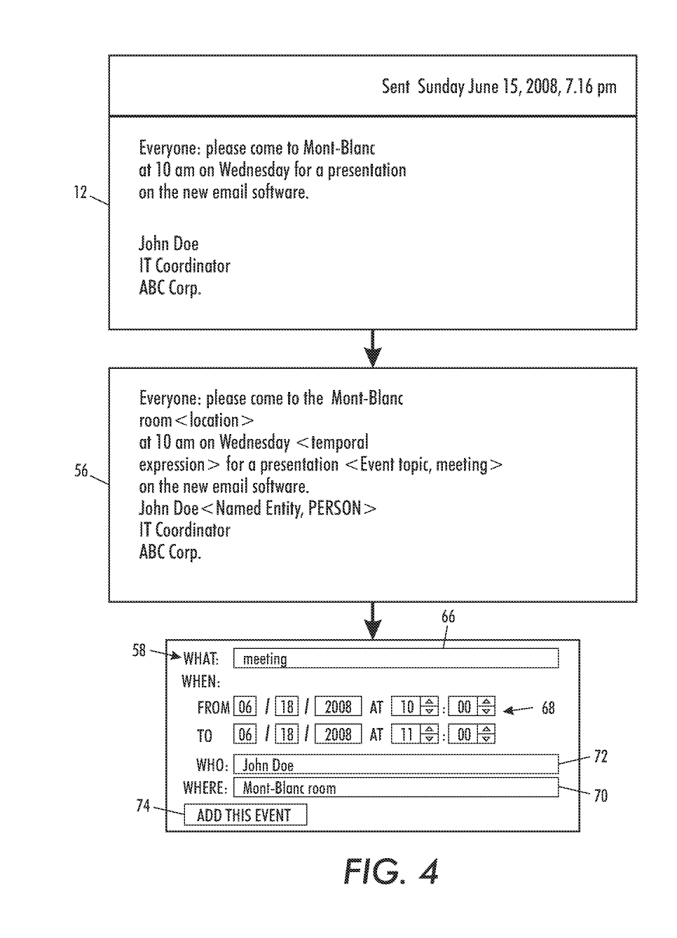

The output of the temporal module is processed text 56 (FIG. 4), which has been marked or otherwise annotated with information concerning candidate events, such as candidate participants, locations, event topics, and linked temporal expressions. Extraneous information no longer required may be omitted, such that the output may simply be a list in which the relevant content is indexed, such as for the content shown in FIG. 4:

PARTICIPANT [John Doe]

LOCATION [Mont-Blanc room]

TEMPORAL EXPRESSION [at 10 am on Wednesday]

TOPIC [meeting]

### Computation of Temporal Information (S120)

Once the temporal module 42 has completed the linguistic processing, relevant portions of the e-mail content appropriately tagged or otherwise annotated with temporal expressions, and corresponding events, locations, and persons are output to the temporal information computation module 44, which applies rules for determining dates and times, based on the temporal expression. The temporal information computation module 44 computes one or more candidate events for the e-mail message 12.

Each identified date/time is inferred to be in the future and uses the sent date/time as a reference. Thus, for example, the temporal expression “in two hours” is interpreted as being two hours after the time the e-mail 12 was sent and the date is computed the same way. “Next Monday”, is computed as the next subsequent Monday. For expressions which are indicative of duration, such as “the meeting will last two hours,” the module computes the end time as being two hours after the start time. The temporal information computation module 44 can be implemented in Java, Python, or any other suitable programming language.

Once the module 44 has computed one or more dates/times for the candidate event, the information is used to populate appropriate fields of a blank predefined candidate event template by the candidate event generation module 46.

### Presenting of Candidate Calendar Entries to the User (S124)

In the illustrated embodiment, the presenting step includes displaying a candidate calendar entry 58, as illustrated in FIG. 4, transiently on the user's screen. If the system 10 finds one or more candidates that could be a calendar event, a small window pops up in the mailer, containing a list of one or more suggested events. This window can simply be ignored if no event is relevant. This is comparable to the behavior of Microsoft Outlook, where a temporary window pops up, when a new message is received. The user may decide to activate this window in order to edit its content. Other methods are also contemplated for presenting the candidate calendar entry to the user, such as delivery of a computer-generated audible message.

The candidate calendar entry generation module 46 uses information output by the temporal information computation module 44 to generate a candidate calendar entry 58. The candidate calendar entry 58 may be generated for display, e.g., as a pop up window, and module 46 causes it to be displayed to a user of the computer 20, e.g., via a graphical user interface (GUI) 60 (FIG. 1). The graphical user interface 60 may utilize the Windows® Operating System from Microsoft, Inc. or the Mac® Operating System from Apple Computer, Inc. Such graphical user interfaces have the characteristic that a user may interact with the computer system 20 using a cursor control device and/or via a touch-screen display, rather than solely via keyboard input device. Such systems also have the characteristic that they may have multiple “windows” wherein discrete operating functions or applications may occur.

In the exemplary embodiment, the GUI 60 comprises a display 62, such as an LCD screen, and a user input device 64, operatively connected with the computer 20, such as a keyboard, keypad, touch screen, cursor control device, such as a mouse or track ball, or combination thereof. The user input device 64 allows a user to accept, modify, or delete the candidate calendar entry 58. For example, the user may click on or otherwise actuate one or more fields 66, 68, 70, 72 of the displayed candidate calendar entry 58 and modify or delete the content of the field or drag and drop it into another field. If a user decides to add the candidate event to the user's calendar, the user may click on an appropriate accept button 74, or otherwise indicate acceptance of the candidate calendar entry. The system 10 then sends event data 80 to the calendar update module 18 for updating the calendar in accordance with the user accepted calendar entry.

FIG. 4 illustrates an exemplary screenshot of a candidate calendar entry 58 derived from an incoming e-mail 12, as it may be displayed on the GUI 60 in which the fields include an event topic field 66 which may show a default “meeting” entry if no specific event topic has been identified from the e-mail, a date/time field or fields 68, a location field 70, and a participant field 72 (e.g., person or organization). As will be appreciated, fewer or more fields may be displayed. One or more of the fields may be left blank.

The interface 60 can be non-intrusive. This means that no action by the user is necessary. An intervention by the user is needed only if the user wishes to add a suggested event to the user's calendar. In the exemplary embodiment, the candidate calendar entry 58 is transient and disappears after a preselected time period (e.g., in less than 1 minute, e.g., 10 seconds or less) without requiring any action by the user. For example, the entry 58 may be displayed for about 5 seconds in one region of the user's screen and disappear thereafter if the user takes no action. The candidate calendar entry 58 is also visually discreet, allowing the user to continue working on whatever application is currently running on the computer without interruption. For example, the pop up box may occupy a minor portion of the screen without impeding visibility of most of the user selectable functions displayed by the application. To actively remove the candidate calendar entry 58 from the screen, the user may click on a delete symbol 76.

If one event is considered as relevant (or partly relevant), the corresponding information can be edited (if for instance, the user decides to enrich the information) and the event is then added into the calendar in one click (S126).

The method illustrated in FIG. 2 may be implemented in a computer program product that may be executed on a computer. The computer program product may be a tangible computer-readable recording medium on which a control program is recorded, such as a disk, hard drive, or may be a transmittable carrier wave in which the control program is embodied as a data signal. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, transmission media, such as acoustic or light waves, such as those generated during radio wave and infrared data communications, and the like, or any other medium from which a computer can read and use.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, or PAL, or the like. In general, any device, capable of implementing a finite state machine that is in turn capable of implementing the flowchart shown in FIG. 2, can be used to implement the event extraction method.

Without intending to limit the scope of the exemplary embodiment, the following examples demonstrate the applicability of the system 10 to various e-mail messages.

### EXAMPLES

### 1. Dealing with Events

A user receives the following e-mail message in March 2008.
Everyone: please come to Mont-Blanc at 10 am on Wednesday for a presentation on the new e-mail software.
John Doe
IT Coordinator
ABC Corp.

The system automatically analyzes this e-mail. Here, the event extraction system 10 identifies Mont Blanc as being a room in the building, using the Named Entity Recognition component 38. The temporal expression (10 am on Wednesday) is interpreted as referring to 10 am on the next subsequent Wednesday to the e-mail sent date. If the system does not recognize “presentation” as being a type of meeting or as being in a temporal relationship with the temporal expression, the generic word “meeting” is used for the event.

The system 10 will then produce a summary of the information extracted from that mail and proposes a candidate calendar entry as a pop-up window 58 with the actual date and location data (FIG. 4).

### 2. Time Frame

In this example, the user receives a message in which more than one date is present.
Please use the link below in order to take the EES survey on line.
URL: https://www.geneseesurvey.com
Genesee (the company processing the survey) will be sending you an e-mail on Monday May 5th with your unique pin, the Subject Line of the mail will be: ‘ABC Co. Employee Engagement Survey 2008’.
The time frame when you can fill in the survey is 7-25 May.

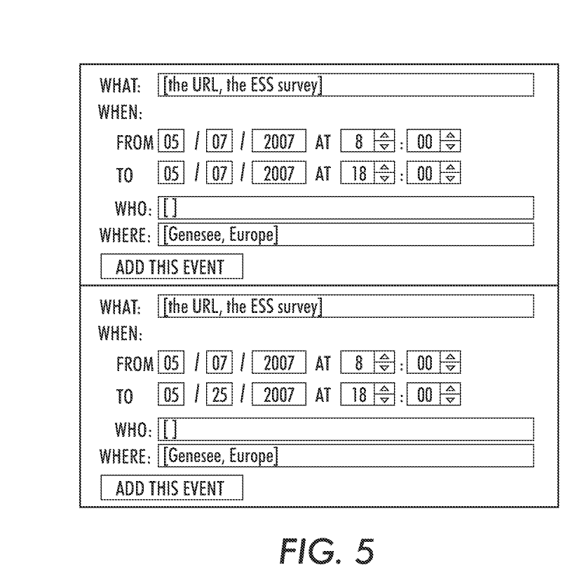

The system 10 then proposes two windows to describe the time frame of that event, as illustrated in FIG. 5. Here, the system has incorrectly identified Genesee as a place, which could be attended to by the user before accepting the second event.

### 3. Table

In this example, the information is spread over different columns of a table. However, since the dates are written in plain text, the system will be able to extract the actual information, despite the absence of regular sentences.

The Center's seminar schedule is available online. Our next seminar will be:

| | |
|---|---|
| Setting | Thursday May 10, 2008 at 11:00 AM in Mont- |
| | Blanc Room |
| Title | Learning automata on protein sequences |
| Abstract | Learning automata has been studied for a long |
| | time in the Grammatical Inference community. In |
| | this talk, I will focus on the application of |
| | grammatical inference techniques to learning (non |
| | deterministic) finite state automata modeling |
| | families of proteins. . . . |
| Speaker | François Coste, Symbiose project, INRIA Rennes, |
| | Rennes, France: Researcher |

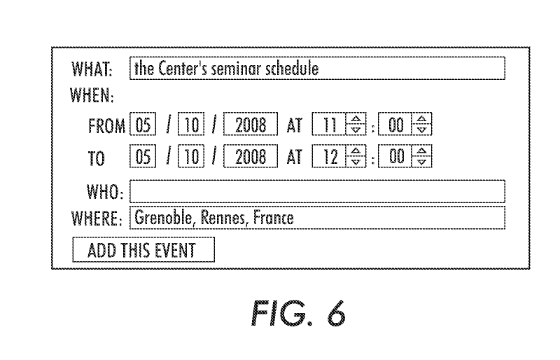

FIG. 6 shows a candidate event generated from the data extracted from the above table.

### 4. Quick and Short Answer

The e-mail, received on the 18^{th} of Jun., 2007, is reduced to a simple sentence, with almost no context:
Hi John,
I am not sure I can make it. Why not tomorrow at 10?
   >Hi Alan,
   >Regarding your last message, I suggest to you a short
   >meeting today at 2 or 3.
      > . . .

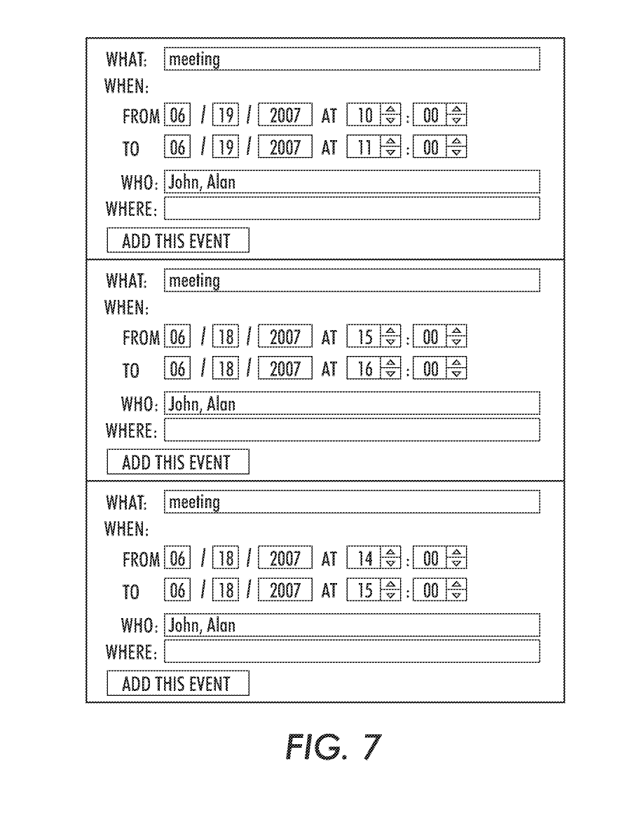

The system 10 then extracts all possible events from this short text and proposes three different dates, with different meeting hours (FIG. 7).

The exemplary system 10 thus described is not limited to the detection of linguistic references to dates and events. In addition, the system makes it possible to detect candidate calendar events from full-text e-mails. Thus, for example, when given the sentence: “Meeting in two days in Room 10 with Peter” a conventional system could not correctly assess such a sentence. If the system is equipped with the capability to detect time references, such as “days” it may at best be able to identify “in two days” as a period of time, i.e., two days duration, instead of a date.

In summary, a system has been disclosed that can spot event dates in e-mails. The system can recognize named entities such as person names; company names; and locations. The system can propose event dates in a floating window together with named entity information. The system allows users to decide whether to use this date or not. The system then stores this event in the user's calendar system.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An event extraction system comprising:
a temporal module comprising instructions stored in memory for extracting temporal expressions in syntactically parsed text content of an electronic mail message;
a calendar entry generation module comprising instructions stored in memory for generating a candidate calendar entry based on an extracted temporal expression and for presenting it to a user for consideration as a calendar entry; and
a processor associated with the temporal module and calendar entry generation module which executes the instructions.

2. The event extraction system of claim 1, further comprising:
a temporal information computation module which computes temporal information from the temporal expressions, the temporal information computation module being configured for inferring at least one of a future event date and a future event time from the temporal expression based on at least one of the electronic mail sent date and sent time.

3. The event extraction system of claim 1, further comprising:
a lexicon accessible to the temporal module, which identifies anchor words as candidates for forming temporal expressions, the temporal module including instructions for grouping the anchor word with other words in the text content that are related to an identified anchor word to form the temporal expression.

4. The event extraction system of claim 1, wherein the temporal module includes instructions for identifying a temporal relation between a temporal expression and a candidate event in the text content.

5. The event extraction system of claim 4, wherein the temporal module includes instructions for accessing a lexicon of events for identifying candidate events in the text content.

6. The event extraction system of claim 5, wherein the lexicon stores event words in an ontology whereby a group of related events are linked to a common event class.

7. The event extraction system of claim 1, wherein the calendar entry generation module is configured for receiving user modifications to the candidate calendar entry.

8. The event extraction system of claim 1, wherein when a user accepts a candidate calendar entry, the event extraction system provides information to an associated calendar update module for updating the user's calendar.

9. The event extraction system of claim 1, wherein the calendar entry generation module displays the candidate calendar entry transiently, whereby the candidate calendar entry disappears if a user chooses to ignore the candidate calendar entry.

10. The event extraction system of claim 1, wherein the candidate calendar entry generation module automatically populates fields of a calendar entry form, the fields being selected from:
an event topic field;
a participant field;
an event location field; and
a date/time field.

11. The event extraction system of claim 1, wherein when the temporal module identifies more than one temporal expression, the candidate calendar entry generation module generates a plurality of candidate calendar entries.

12. The event extraction system of claim 1, further comprising a named entity recognition system which executes instructions for identifying at least one of a participant and an event location from the text content.

13. The event extraction system of claim 1, further comprising a text extraction component which automatically extracts the text content of the electronic message.

14. A computer system comprising;
the event extraction system of claim 1;
a mailer which receives and displays incoming electronic messages in communication with the event extraction system; and
a calendar update module which receives information on user-accepted calendar entries from the event extraction system and updates a calendar based thereon.

15. A computer implemented method for extracting events from an electronic message comprising:
extracting temporal expressions in text content of an electronic mail message;
generating a candidate calendar entry based on an extracted temporal expression; and
presenting the candidate calendar entry to a user for consideration as a calendar entry.

16. The method of claim 15, further comprising:
accessing a lexicon to identify anchor words as candidates for forming temporal expressions, optionally in combination with other words of the text content.

17. The method of claim 15, further comprising:
applying one or more rules for identifying a temporal relation between a temporal expression and a candidate event in the text content.

18. The method of claim 15, further comprising:
accessing a lexicon of stored events for identifying candidate events in the text content.

19. The method of claim 15, further comprising:
applying rules for computing dates and times from the temporal expressions, based on at least one of the electronic mail sent date and sent time.

20. The method of claim 15, wherein the presenting comprises displaying the candidate calendar entry transiently, whereby the candidate calendar entry disappears if a user chooses to ignore the candidate calendar entry.

21. The method of claim 15, further comprising:
providing for receiving user modifications to the candidate calendar entry.

22. The method of claim 15, further comprising:
providing for updating the user's calendar with information from an accepted candidate calendar entry.

23. The method of claim 15, wherein the presenting includes automatically populating fields of a calendar entry form, the fields being selected from:
an event topic field;
a participant field;
an event location field; and
a date/time field.

24. A computer program product encoding instructions, which when executed on a computer causes the computer to perform the method of claim 15.

25. An automated event extraction system comprising memory which stores instructions and a processor which executes the instructions for:
extracting temporal expressions in text content of an electronic mail message;
identifying events associated with the extracted temporal expressions;
computing temporal information from the temporal expressions;
generates a candidate calendar entry based on the computed temporal information; and
displaying the candidate calendar entry transiently on a screen.
